(19) United States
(12) Patent Application Publication
(10) Pub. No.: US 2015/0206466 A1
(43) Pub. Date: Jul. 23, 2015

(54) METHODS AND APPARATUS FOR DISPLAYING IMAGES

(71) Applicant: PLASTIC LOGIC LIMITED, Willingham, Cambridgeshire (GB)

(72) Inventors: William Reeves, Willingham (GB); Robert Jackson, Cambridge (GB)

(21) Appl. No.: 14/413,001

(22) PCT Filed: Jul. 25, 2013
(86) PCT No.: PCT/GB2013/051986

§ 371 Date: Jan. 5, 2015

(30) Foreign Application Priority Data
Jul. 26, 2012 (GB) 1213293.2

(51) Int. Cl. G09G 3/00; G09G 3/20; G09G 3/34

(52) U.S. Cl. CPC G09G 3/006; G09G 3/344; G09G 3/2003; G09G 2320/0271; G09G 2320/0606; G09G 2354/00

(57) ABSTRACT

A method of testing an electronic electrophoretic display comprising: connecting a remote device to said electronic display and displaying a user interface on said remote device. A user input to begin testing is then received and an an initialisation signal is sent from said remote device to said electronic display to clear said display. Another user input to display an image is then received and an image file is sent from said remote device to said electronic display to test said electronic display.

### FIELD OF THE INVENTION

This invention generally relates to an electronic display. The invention also relates to methods and apparatus for processing images to be displayed on the electronic display.

### BACKGROUND TO THE INVENTION

There are various types of electronic displays, for example reflective displays such as electrophoretic, electrowetting, electrofluidic and photonic, or emissive displays such as LCD. Such electronic displays may be incorporated in an electronic document reader which is a device such as an electronic book which presents a document to a user on a display to enable the user to read the document.

When power is removed from emissive displays (such as LCD, OLED and Plasma) they revert to an off-state. This state is known and any colour can be driven accurately from this starting point. Reflective displays, e.g. electrophoretic displays, differ since they retain the last image that was written to them. Therefore, the display must be unwritten before it is rewritten. An electrophoretic display is a display which is designed to mimic the appearance of ordinary ink on paper and may be termed electronic paper, e-paper and electronic ink. Electrophoretic display media is unlike most display technologies.

Typically the image displayed on an electrophoretic display is greyscale (or monochrome). Displaying coloured documents using a black and white display often results in the loss of important information. Colours that were used to distinguish different parts of content can be rendered to grey levels that are so similar that it is difficult to tell the difference. Similarly, coloured text may be converted to a grey level so light it makes it difficult to read.

E-paper display displays have a unique challenge over some other display technologies; they neither support the number of colours that an LCD has, neither do they have the resolution that printed media have to enable efficient “half toning” or “dithering”. When displaying content, originally designed for colour display or print, these deficiencies can lead to a degraded user perception of quality, and in the worst case information can easily be lost.

The applicant has thus recognised the need for an improved display, particularly but not limited to an electrophoretic display.

### SUMMARY OF THE INVENTION

According to a first aspect of the invention, there is provided a method of testing an electronic display comprising:
connecting a remote device to said electronic display;
displaying a user interface on said remote device;
receiving, at said remote device, a user input to begin testing;
sending an initialisation signal from said remote device to said electronic display;
receiving, at said remote device, a user input to display an image; and
sending an image file from said remote device to said electronic display to test said electronic display.

According to a second aspect of the invention, there is provided a remote device which is configured to test an electronic display which is connected to said remote device, the remote device comprising a processor which is configured to:
display a user interface on said remote device;
receive a user input to begin testing;
receive a user input to display an image; and
send an image file to said electronic display to test said electronic display.

Said electronic display is preferably an electrophoretic display. Electrophoretic display media are unlike most display technologies. When power is removed from conventional displays (such as LCD, OLED and Plasma) they revert to an off-state. This state is known and any colour can be driven accurately from this starting point. Reflective displays differ since they retain the last image that was written to them. Therefore, the display must be unwritten before it is rewritten. Accordingly, said initialisation signal is preferably configured to clear the display, e.g. by selecting all white. The initialisation signal is sent in response to the user input to begin testing and thus the user input to begin testing is preferably a separate step from the user input to send an image file.

The following features apply to both aspects.

The user interface may comprise a start button. A user input to begin testing may thus comprise receiving a user selection of said start button. For example, said user interface may be touch sensitive using standard technology and a user may select said start button by pressing on the button. Alternatively, a user may click on said button using other known technologie, e.g. by moving a mouse cursor over said button and selecting said button. The user interface may comprise a next button and a user input to display an image may comprise receiving a user selection of said next button in a similar manner to that of said start button. Said user selection may be repeated selection of said next button and an image file may be sent after each user selection of said next button. Thus a user is able to scroll through a sequence of images by clicking on “next” multiple times. Only one of the next and start button may appear on the user interface. The next button may appear after the initialisation phase is complete. The start button may reappear and the next button disappear once a user has scrolled through all images.

The user interface may comprise a browse button which when selected in any known standard manner by a user causes said user interface to display a select image dialog. Said receiving a user input to display an image may comprise receiving a user selection of said browse button followed by a user selection of an image within said select image dialog.

Said image file may be converted to an appropriate format before sending to said electronic display. A user input may be received to convert said image file. Said user input may comprise selecting grey levels for said converted image file.

Said remote device may be configured to automatically detect that said electronic display is not working properly. Thus, in response to said sending, said remote device may generate an error message if said electronic display is unresponsive. Alternatively, a user may be able to provide feedback to said remote device and/or to adjust settings on the electronic device if said image file sent to the electronic display is not correctly displayed.

Thus according to another aspect of the invention, there is provided a method of converting an image file to an appropriate format for an electronic display comprising:
connecting a remote device to said electronic display;
displaying a user interface on said remote device;
receiving, at said remote device, a user selection of an original format and a converted format for said image file;
receiving, at said remote device, a user selection of said image file to be converted,
receiving, at said remote device, a user selection of grey levels within said converted format, and
converting said image file according to said user selections.

This aspect may be combined with the other aspects.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF THE DRAWINGS

These and other aspects of the invention will now be further described by way of example only, with reference to the accompanying figures in which:

FIGS. 1a and 1b show respectively, a front view and a rear view of an electronic display;

FIG. 2a shows a detailed vertical cross-section through the display of FIG. 1;

FIG. 2b shows an example of a waveform for an electrophoretic display of FIG. 1;

FIG. 3 is a block diagram of control circuitry suitable for the display of FIG. 1;

FIG. 4a is a flowchart of one method of displaying an image on the electronic display of FIG. 3;

FIGS. 4b and 4c are screenshots of a graphical user interface for configuring the electronic display of FIG. 3;

FIG. 4d is a dialog window which may be initiated as part of the graphical user interface;

FIGS. 4e and 4f are error message which may appear in the method of FIG. 4a;

FIGS. 5a and 5b are screenshots of graphical user interfaces for converting a file for the electronic display of FIG. 3;

FIG. 5c is a flow chart for converting a file for the electronic display of FIG. 3, and

FIG. 6 is a schematic block diagram of the components of a remote device.

### DETAILED DESCRIPTION OF THE DRAWINGS

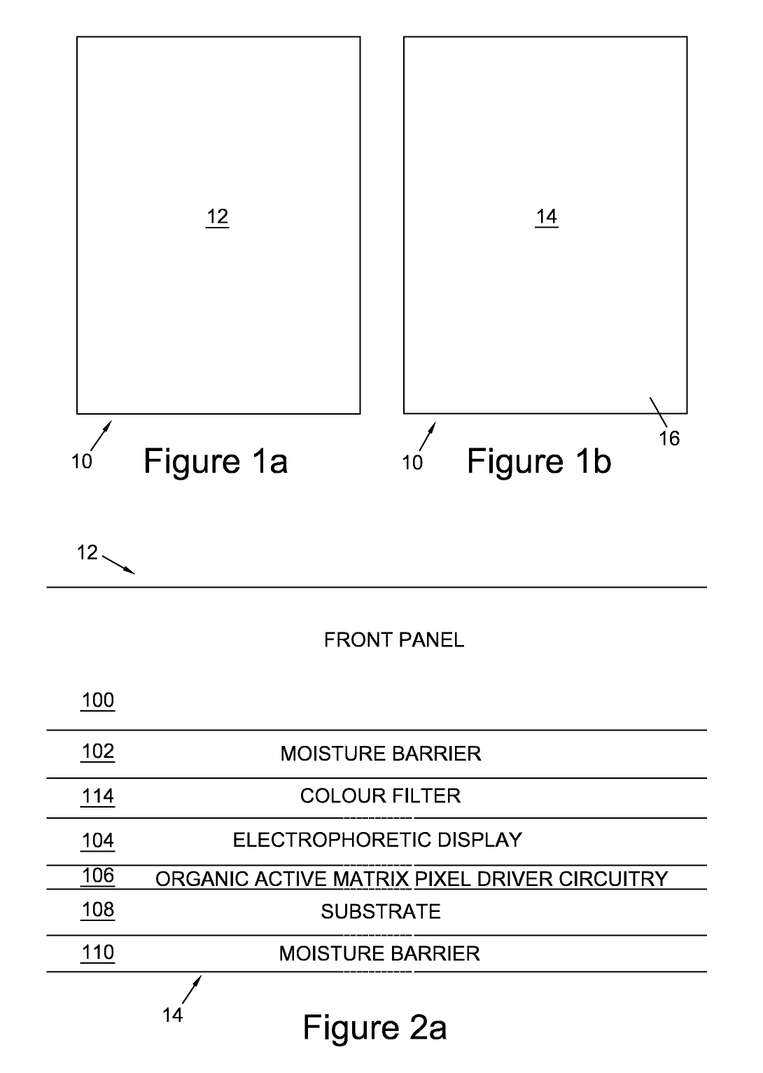

FIGS. 1a and 1b schematically illustrate an electronic display 10 having a front display face 12 and a rear face 14. The display surface 12 is substantially flat to the edges of the device and may as illustrated lack a display bezel. However, it will be appreciated that the electronic (electrophoretic) display may not extend right to the edges of the display surface 12, and rigid control electronics may be incorporated around the edges of the electronic display.

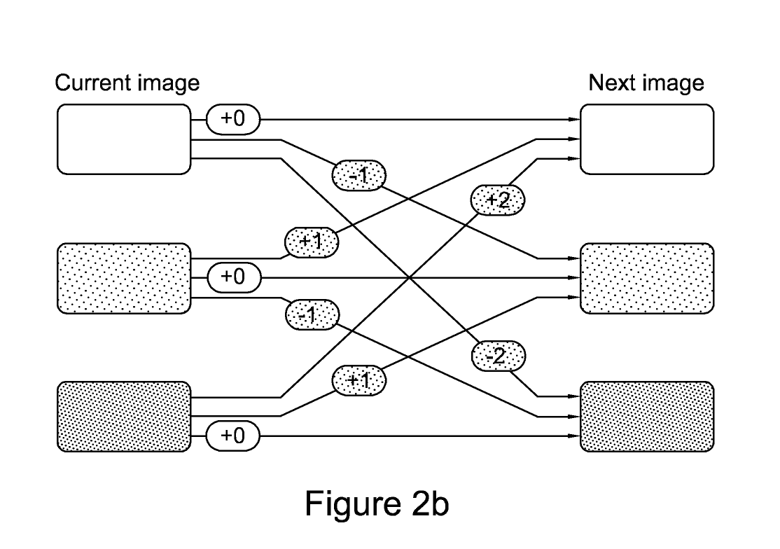

Referring now to FIG. 2a, this illustrates a vertical cross-section through a display region of the device. The drawing is not to scale. The structure comprises a substrate 108, typically of plastic such as PET (polyethylene terephthalate) on which is fabricated a thin layer 106 of organic active matrix pixel driver circuitry. The active matrix pixel driver circuitry layer 106 may comprise an array of organic or inorganic thin film transistors as disclosed, for example, in WO01/47045. Attached over this, for example by adhesive, is an electrophoretic display 104. The electrophoretic display is a display which is designed to mimic the appearance of ordinary ink on paper and may be termed electronic paper, e-paper and electronic ink. Such displays reflect light and typically the image displayed is greyscale (or monochrome). It will be appreciated that other displays may be used in place of the electrophoretic display.

A moisture barrier 102 is provided over the electronic display 104, for example of polyethylene and/or Aclar™, a fluoropolymer (polychlorotrifluoroethylene-PCTFE). A moisture barrier 110 is also preferably provided under substrate 108. Since this moisture barrier does not need to be transparent preferably moisture barrier 110 incorporates a metallic moisture barrier such as a layer of aluminium foil. This allows the moisture barrier to be thinner, hence enhancing overall flexibility. In preferred embodiments the device has a substantially transparent front panel 100, for example made of Perspex®, which acts as a structural member. A front panel is not necessary and sufficient physical stiffness could be provided, for example, by the substrate 108 optionally in combination with one or both of the moisture barriers 102, 110.

A colour filter 114 is optionally applied over the display. Such a filter is a mosaic of small filters placed over the pixel sensors to capture colour information and is explained in more detail below. The filter may be a RGBW (Red, Green, Blue, White) filter or another equivalent version.

Reflective displays, e.g. electrophoretic display media, are unlike most display technologies. When power is removed from conventional displays (such as LCD, OLED and Plasma) they revert to an off-state. This state is known and any colour can be driven accurately from this starting point. Reflective displays differ since they retain the last image that was written to them. Therefore, the display must be unwritten before it is rewritten. Waveforms are set of “transitions” that tell a pixel how to change from one image to the next; essentially a guide on how to turn every grey level to every other grey level. For a display capable of three grey levels this results in a waveform with nine transitions as shown schematically in FIG. 2b.

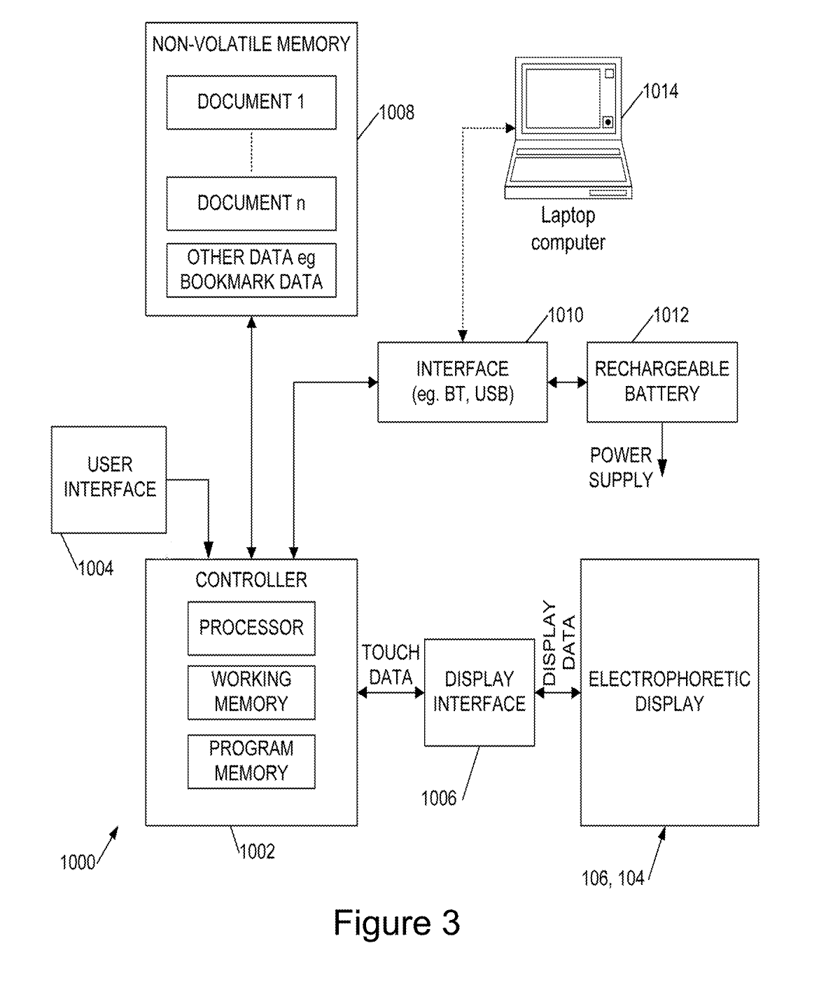

Referring now to FIG. 3, this shows example control circuitry 1000 suitable for the above-described electronic display. The control circuitry comprises a controller 1002 including a processor, working memory and programme memory, coupled to a user interface 1004 for example for controls 130. The controller is also coupled to the active matrix driver circuitry 106 and electrophoretic display 104 by a display interface 1006 for example provided by integrated circuits. In this way controller 1002 is able to send electronic document data to the display 104 and, optionally, to receive touch-sense data from the display. The control electronics also includes non-volatile memory 1008, for example Flash memory for storing data for one or more documents for display and, optionally, other data such as user bookmark locations and the like. The skilled person will appreciate that processor control code for a wide range of functions may be stored in the programme memory.

An external interface 1010 is provided for interfacing with a computer such as laptop, PDA, or mobile or ‘smart’ phone 1014 to receive document data and, optionally, to provide data such as user bookmark data. The interface 1010 may comprise a wired, for example USB, and/or wireless, for example Bluetooth™ interface and, optionally, an inductive connection to receive power. The latter feature enables embodiments of the device to entirely dispense with physical electrical connections and hence facilitates inter alia a simpler physical construction and improved device aesthetics as well as greater resistance to moisture. A rechargeable battery 1012 or other rechargeable power source is connected to interface 1010 for recharging, and provides a power supply to the control electronics and display.

Electronic documents to be displayed on the reader may come from a variety of sources, for example a laptop or desktop computer, a PDA (Personal Digital Assistant), a mobile phone (e.g. Smart Phones such as the Blackberry™), or other such devices. Using the wired (e.g. USB etc) or wireless (e.g. Bluetooth™) interfaces, the user can transfer such electronic documents to the document reader in a variety of ways, e.g. using synchronisation or “printing”. Electronic documents may comprise any number of formats including, but not limited to, PDF, Microsoft Word™, Bitmaps, JPG, TIFF and other known formats.

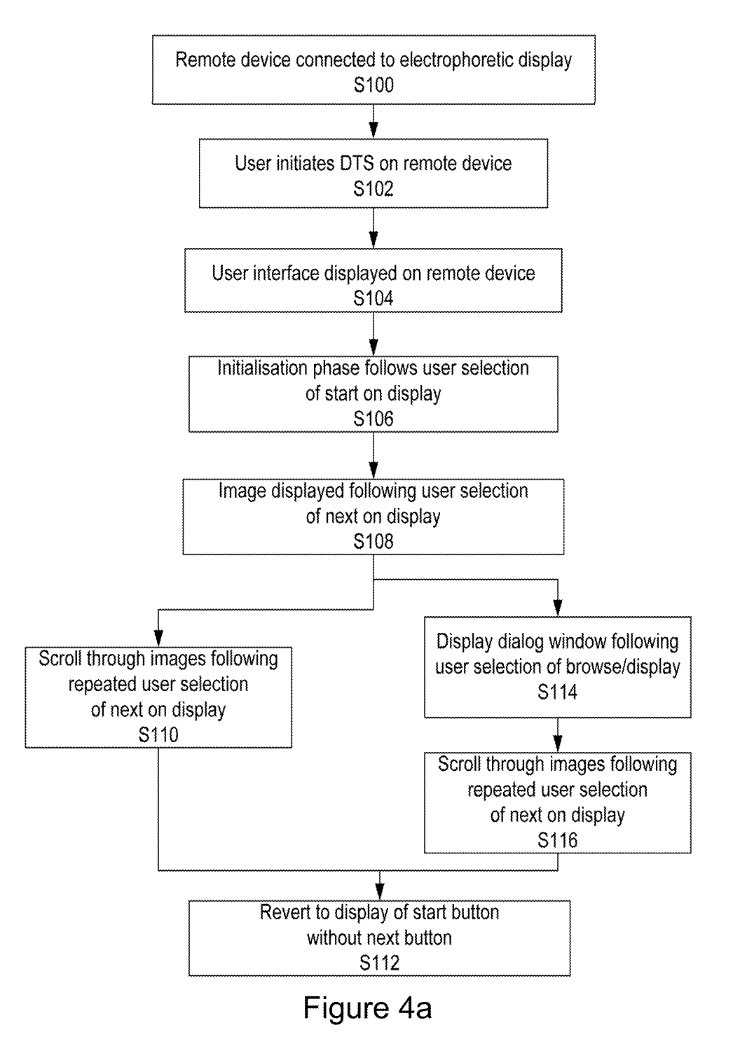

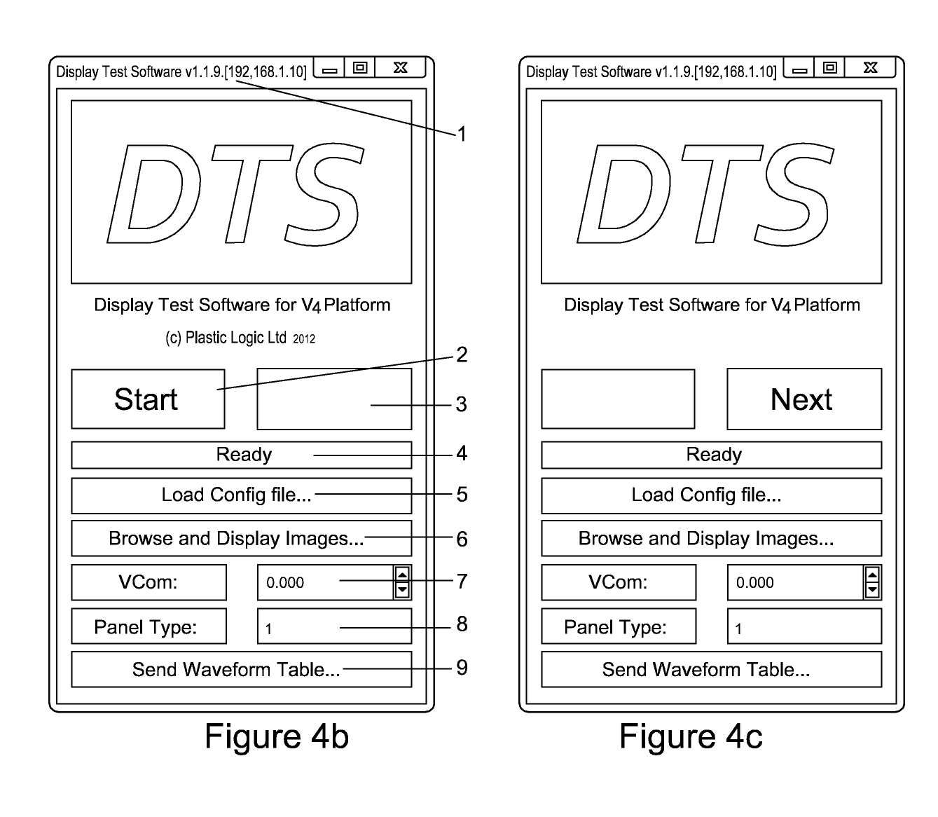

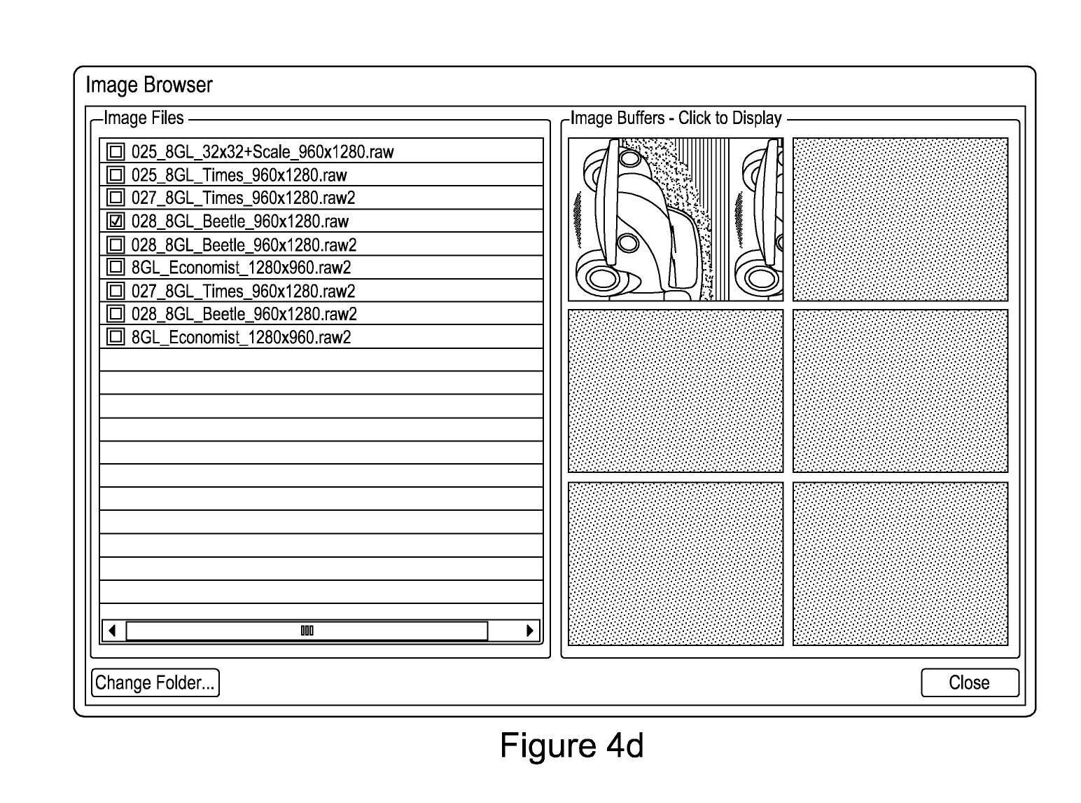

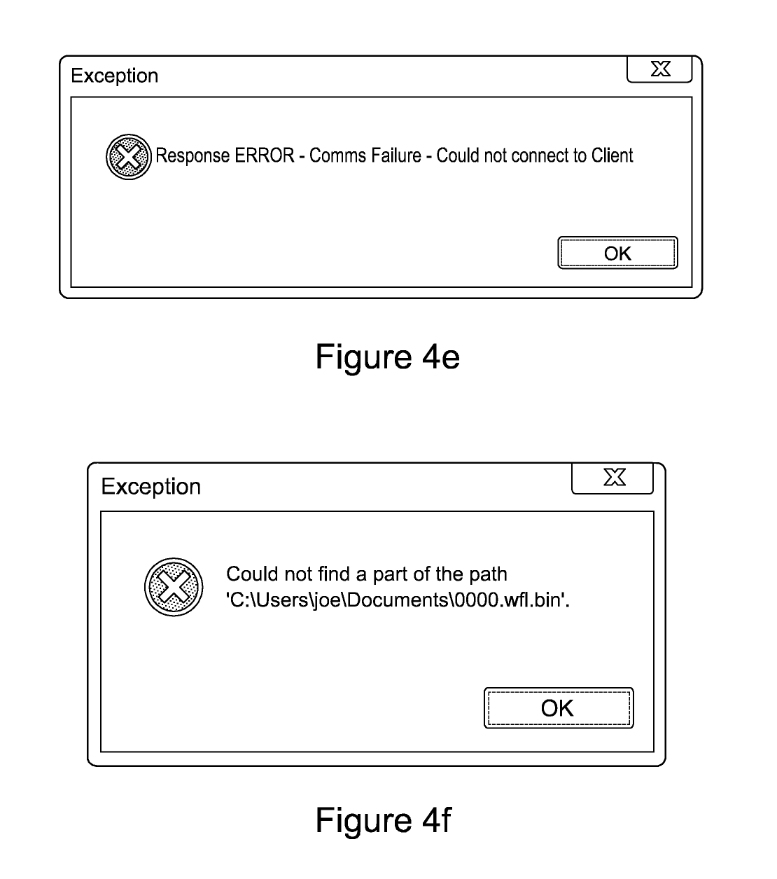

FIGS. 4a to 4f illustrate one method for displaying an image on the display. The first step S100 is to connect the control circuitry (display electronics) to a remote device (e.g. PC). A user working on the remote device initiates an application to test the electrophoretic display S102; the application may be termed display test software (DTS). The DTS is configured by an xml configuration file. When the program starts it will look for a configuration file in the same folder named “config.dts”. The configuration file contains the list of image files to display on the Plastic Logic Display Panel. The configuration is contained in XML elements. An xml element is delimited by angular brackets, similar to HTML e.g.:
<AnElement>The value of the element</AnElement>

It will be appreciated that using an XML configuration file is just one suitable format and other formats may be used.

The DTS causes a user interface as shown in FIG. 4b to be displayed on the remote device S104. The user interface comprises a title bar 1 which contains the the Program Name, the software version, and the IP address contained in the configuration file. There is also a start button 2 which prepares the electrophoretic display. A user selects the “start” button on the user interface which initiates an initialisation phase on the display S106. The initialisation phase may clear the display when the start button is pressed. This may for example be controlled by an element <StartWithTripleWhiteErase>. The value can be “true” or “false”. For example to enable an initialisation update:

<StartWithTripleWhiteErase>true</StartWithTripleWhiteErase>

The user interface of FIG. 4b is changed to remove the start button and display a “next” button 3 as shown in FIG. 4c. A user selects the “next” button and an image is displayed on the display. Clicking on the Next button will display the next image in the list in the “<ConfigItems>” section of the configuration file. The <ConfigItems> contains a sequence of <DTSConfigImageFile> items, which specifies the list of images to be displayed S110. The images must be in the correct image format (for example .raw, .raw2). Information on how to convert from standard image formats can be found in the Image Converter (RawCon) section below. Note that the paths can be relative to the directory in which the executable is running.

For example, to display the images C:\Users\Joe\Documents\image_{—}1_{—}960×1280.raw2” and “C:\Users\Joe\Documents\image_{—}2_{—}960×1280.raw2”, the <ConfigItems> section of the configuration file would be:

<ConfigItems>

<DTSConfigImageFile>

<ImageFilePath>C:\Users\Joe\Documents\image_1_960x1280.raw2</ImageFilePath>

<X>0</X>
<Y>0</Y>

</DTSConfigImageFile>
<DTSConfigImageFile>

<ImageFilePath>C:\Users\Joe\Documents\image_2_960x1280.raw2</ImageFilePath>

<X>0</X>
<Y>0</Y>

</DTSConfigImageFile>

</ConfigItems>

The <X> and <Y> elements specify the x,y offset of the image when displayed. For full sized images the offset is 0,0.

Once all images have been displayed, the Next button disappears and the Start button reappears S112.

The user interface also comprises a status box 4 immediately below the Start and Next button which displays some helpful text about the status of the program. A load Config File button 5 is provided to enable a user to bring up a file dialog to choose a new configuration file. Similarly, a browse and display images button 6 is provided to enable a user to brings up a dialog to select images from the file system and display them on the display S114. This enables a user to select a new set of images to scroll through using the next button 3 S116.

FIG. 4d illustrates the user interface after the browse and display images button 6 is selected. As shown a dialog which allows a user to select images from the file system is displayed on the user interface. The dialog comprises a list of available files on one side of the display and a preview of a selected file in an image buffers window on the other side of the display. Checking the checkbox next to each listed file will preview the image in the image buffers window. Clicking on the image will cause it to be displayed on the electrophoretic display. The orientation of the image in the preview may be incorrect; however the orientation will be correct when displayed on the electrophoretic display. The dialog also comprises a change folder button which brings up a Folder Browse dialog to allow a user to select a Folder and click ok. Any .raw or .raw2 images in the folder will be listed in the Image Files list.

Returning to FIG. 4b, the user interface also comprises other buttons allowing a user to change the settings, e.g. a Vcom button 7, a panel type button 8 and a send waveform table button 9. If a user selects one of these buttons, the user is presented with a dialog to enable them to change this setting but in general this is not necessary. The VCom value is contained in the waveform file specified in the configuration file. Typically, this element is not used and is set as 0. Other elements in the configuration file may be also be unused, e.g. <PreLoadImageBuffers> and <PowerDownSequenceMode>.

The display electronics will normally be configured with the correct panel type. Furthermore, it is not necessary to send a waveform table because this is generally included in the configuration file. The waveform file specified in the configuration file will include waveform information, for example by using the xml element <WaveformLibaryPath>. The waveform file is in a proprietary format. The file extension is “.wfl.bin”. For example, to specify the waveform file “C:\Users\Joe\Documents\12345.wfl.bin”:

<WaveformLibraryFilePath>C:\Users\Joe\Documents\12345.wfl.bin
</WaveformLibraryFilePath>

The DTS will also provide error messages for example as shown in FIGS. 4e and 4f The error message in FIG. 4e may appear if the user interface is unresponsive after pressing start. If this message appears, a user needs to check the Display Electronics is powered and connected, check the IP address in the config file is that of the Display Electronics and check that the remote device is connected to the Display Electronics. Alternatively, the error message in FIG. 4f may appear if the user interface is unresponsive after pressing start. If this message appears, a user needs to check path to waveform file exists and that the waveform file is in the correct format. If both these are correct but on clicking the “Next” button the electrophoretic display still does not update, the user needs to check that the image file name in the config file exists and is a .raw or .raw2 file. The DTS will not automatically convert standard images files. They must be converted with the Image Converter utility.

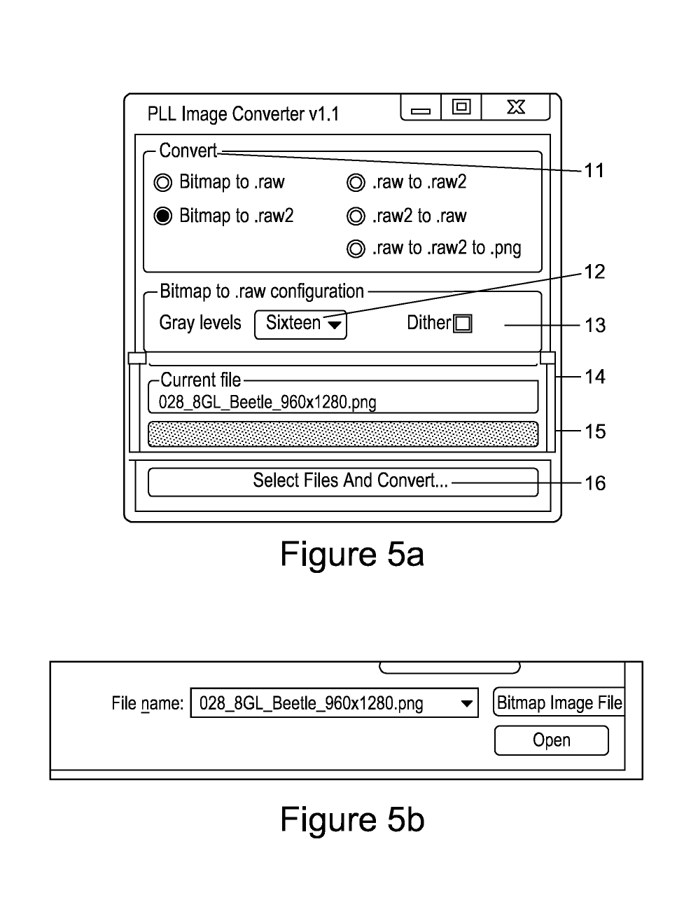

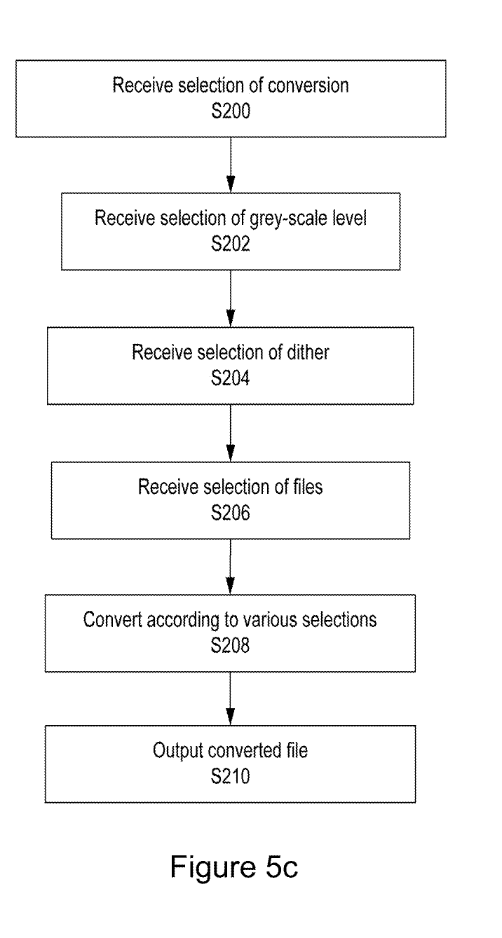

FIG. 5a shows the user interface for the Image Converter utility. The user interface comprises a convert section 11 which enables a user to select various different types of conversion:

“Bitmap to raw” converts various bitmap formats (.bmp, .png, etc) to the format use by the electrophoretic display

“Bitmap to .raw2” converts various bitmaps formats (.bmp, .png, etc) to a compressed format used by the electrophoretic display

“.raw to .raw2” Converts a raw image file to a compressed image file

“.raw2 to saw” Converts a compressed image file to an uncompressed image file

“.raw/.raw2 to .png” converts an image file (compressed or uncompressed) to a PNG file

The user interface also has a drop down grey level menu 12 to select the number of grey levels in the image file for the display. There is an option for dither selection 13. When checked the image file will be dithered. Dithering can improve the presentation of many images (e.g. photos) but should not be used for text-based images. The user interface also comprises a file window 14 for displaying the current file being converted when the conversion is running. Similarly, there is a progress window 15 which indicates how much of the conversion has been completed. A select files and convert button 16 brings up a file selection dialog as shown in FIG. 5b. Multiple files can be selected. Clicking OK will start the conversion process. A message will appear warning that files may be overwritten.

FIG. 5c shows the steps in converting a file format. A user selects S100 the type of conversion, e.g. Bitmap to .raw2 and if appropriate the gray scale level S102. A user may select dither S104. A user then selects the “select files and convert” button which brings up a file dialog window to enable a user to select a file. These selections are input to the system which performs the conversion S108 and outputs the converted file S110, e.g. to the DTS. The conversion may change the orientation and change the filename by appending the correct orientation format.

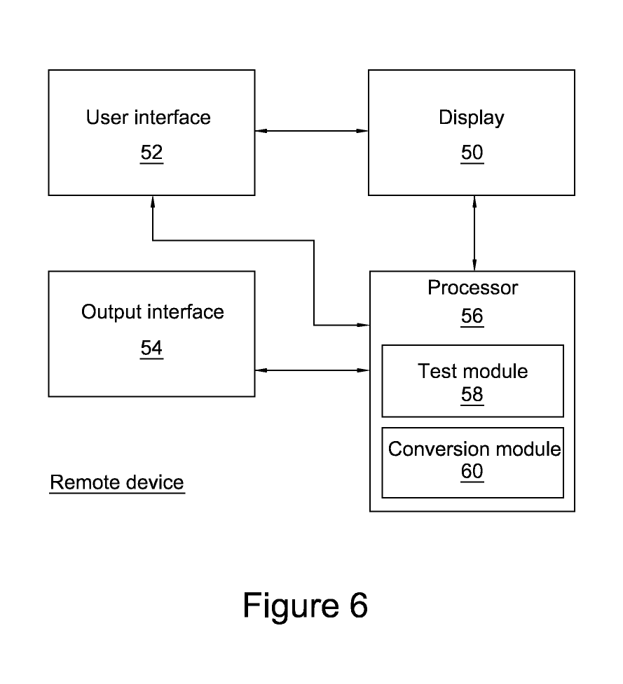

FIG. 6 shows a schematic block diagram of the components of the remote device which may be a laptop computer as shown in FIG. 3. The remote device comprises a display 50 which displays a user interface such as those shown in FIGS. 4b to 4d. The remote device also comprises a user input 52 so that a user can input instructions to the remote device in response to the display on the user interface. The display 50 may comprise touch sensitive technology so that the user input can be integrated with the user interface. Alternatively, the user input may be in the form of a keyboard, mouse or other known input devices. The remote device also comprises an output interface 54 for outputting data to said electronic display.

The remote device also comprises a processor 56 which comprises a test module 58 and a conversion module 60. The processor 56 is connected to the other components. In test mode, the test module 58 is configured to display a user interface on said display and to receive user inputs to begin testing and to display an image. In response to the user inputs, the processor sends an image file to said electronic display via said output interface to test said electronic display.

The processor 56 is also configured to convert image files as shown in FIG. 5c, using the conversion module 60. In this conversion mode, the processor is configured to display a user interface on said display and to receive user inputs to select an image for conversion and to select the formats for the conversion. Additional user inputs may be also received for grey-scale level and/or dither.

FIG. 6 shows a single computing device with a processor having multiple internal components which may be implemented from a single or multiple central processing units, e.g. microprocessors. It will be appreciated that the functionality of the device may be distributed across several computing devices although this is unlikely. It will also be appreciated that the individual components may be combined into one or more components providing the combined functionality. Moreover, any of the modules shown in FIG. 6 may be implemented in a general purpose computer modified (e.g. programmed or configured) by software to be a special-purpose computer to perform the functions described herein.

No doubt many other effective alternatives will occur to the skilled person. It will be understood that the invention is not limited to the described embodiments and encompasses modifications apparent to those skilled in the art lying within the spirit and scope of the claims appended hereto

1. A method of testing an electronic electrophoretic display comprising:
connecting a remote device to said electronic display;
displaying a user interface on said remote device;
receiving, at said remote device, a user input to begin testing;
sending an initialisation signal from said remote device to said electronic display to clear said display;
receiving, at said remote device, a user input to display an image; and
sending an image file from said remote device to said electronic display to test said electronic display.

2. A method according to claim 1 comprising
displaying a user interface comprising a start button and
wherein said receiving a user input to begin testing comprises receiving a user selection of said start button.

3. A method according to claim 1 comprising
displaying a user interface comprising a next button and
wherein said receiving a user input to display an image comprises receiving a user selection of said next button.

4. A method according to claim 3 wherein said receiving a user input to display an image comprises repeatedly receiving a user selection of said next button and wherein sending an image file comprises sending an image file after each user selection of said next button.

5. A method according to claim 1, comprising
displaying a user interface comprising a browse button which when selected by a user causes said user interface to display a select image dialog and
wherein said receiving a user input to display an image comprises receiving a user selection of said browse button followed by a user selection of an image within said select image dialog.

6. A method according to claim 1, wherein, in response to said sending, generating an error message if said electronic display is unresponsive.

7. A method according to claim 1, further comprising
converting said image file to an appropriate format before sending to said electronic display.

8. A method according to claim 7 further comprising receiving a user input to convert said image file.

9. A method according to claim 8, comprising receiving a user input selecting grey levels for said converted image file.

10. A method of converting an image file to an appropriate format for an electronic display comprising:
connecting a remote device to said electronic display;
displaying a user interface on said remote device;
receiving, at said remote device, a user selection of an original format and a converted format for said image file;
receiving, at said remote device, a user selection of said image file to be converted,
receiving, at said remote device, a user selection of grey levels within said converted format, and
converting said image file according to said user selections.

11. Processor control code which when running on a processor causes said processor to carry out the steps of method claim 1.

12. A remote device which is configured to test an electronic electrophoretic display which is connected to said remote device, the remote device comprising:
a display;
a user input for receiving inputs from a user;
an output for outputting data to said electronic display and
a processor which is connected to said user input and said display and which is configured to:
display a user interface on said display;
receive, from said user input, a user input to begin testing;
receive, from said user input, a user input to display an image; and
send an image file to said electronic display to test said electronic display.

13. A remote device according to claim 12 wherein said user interface comprises a start button and said user input to begin testing comprises a user selection of said start button.

14. A remote device according to claim 12 wherein said user interface comprises a next button and said user input to display an image comprises a user selection of said next button.

15. A remote device according to claim 14 wherein said user input to display an image comprises repeated user selections of said next button and wherein said processor is configured to send an image file after each user selection of said next button.

16. A remote device according to claim 12 wherein said user interface comprises a browse button which when selected by a user causes said user interface to display a select image dialog and wherein said user input to display an image comprises a user selection of said browse button followed by a user selection of an image within said select image dialog.

17. A remote device according to claim 12 further comprising a conversion module for converting said image file to an appropriate format before sending to said electronic display.

18. A remote device according to claim 17 wherein said user interface comprises a convert section for selecting a format for converting a selected image file and wherein said processor is configured to receive a user input to convert said image file.

19. A remote device according to claim 18, wherein said convert section comprises a menu for selecting grey levels for converting an image file.
